(19) United States
(12) Patent Application Publication
(10) Pub. No.: US 2015/0154383 A1
(43) Pub. Date: Jun. 4, 2015

(54) DIGITAL RESOURCES MANAGEMENT METHOD AND DEVICE

(71) Applicant: Jinxu Huang, Xiamen (CN)

(72) Inventor: Jinxu Huang, Xiamen (CN)

(73) Assignee: Xiamen Geeboo Information Technology Co., Ltd., Xiamen (CN)

(21) Appl. No.: 14/411,695

(22) PCT Filed: Jul. 3, 2012
(86) PCT No.: PCT/CN2012/078127

§ 371 Date: Dec. 29, 2014

(51) Int. Cl. G06F 21/10

(52) U.S. Cl. CPC G06F 21/10; G06F 2221/0791

(57) ABSTRACT

A method for managing digital resources includes receiving a request submitted by a resource requester for obtaining an authorization to use a specified number of copies of a digital resource. The request includes a use authorization type, ID information of the resource requester, and a digital resource identifier. The method also includes determining based on the ID information whether the resource requester is allowed to obtain the specified number of copies. When the determination results are positive, the specified number of copies is distributed to the resource requester.

### FIELD OF THE INVENTION

The present disclosure relates to the field of information technology, and particularly to a method and a device for managing digital resources.

### BACKGROUND OF THE INVENTION

With the development of information technology and the popularity of mobile internet, digital resources are playing an increasingly important role in people's daily life and work by virtue of their desirable characteristics, such as high-tech contents, environmental friendly, and portability. Under such circumstances, various kinds of digital resource platforms are emerging.

In general, traditional digital resource platforms are free to users, or users have to pay for using the platforms, and thus the circulation modes thereof are not as much as written resources. In addition, infringing copies of digital resources cannot be avoided in an effective way in traditional digital resource platforms, which renders the transmission thereof uncontrollable.

In other words, the existing digital resource management platforms render the circulation modes of resources monotonic, or the legitimate rights and interests of the copyright owners cannot be protected effectively by related technologies. Consequently, the existing digital resource management platforms cannot attract users fully.

### SUMMARY OF THE INVENTION

The present disclosure provides a method and a device for managing digital resources, whereby the digital resources can be circulated in a diversified manner while copyrights can be still protected.

To solve the aforesaid problem, the present disclosure provides a method for managing digital resources, comprising the steps of:

receiving, in a first receiving step, a first request submitted by a resource requester for obtaining an authorization for using a specified number of copies of a digital resource, wherein said first request comprises a use authorization type, an identification information of the resource requester, and a digital resource identifier;

determining, in a first determining step, on the basis of the identification information of said resource requester and said digital resource identifier in said first request, or on the basis of the combination of the identification information of said resource requester, said digital resource identifier, and said use authorization type, whether said resource requester is allowed to obtain the specified number of use authorizations, which correspond to said use authorization type of the digital resource associated with said digital resource identifier; and

distributing, in a first distributing step, when the determination result of said first determining step is positive, to said resource requester the specified number of unique copy identifiers, which correspond to the use authorization type in said first request, from all unique copy identifiers of the digital resource associated with the digital resource identifier in said first request, so that said resource requester is allowed to obtain the corresponding copies of said digital resource according to the distributed unique copy identifiers.

Preferably, the determination result of said first determining step is negative if any one of the following conditions is satisfied:

the use authorization type in said first request does not match with any use authorization type of copies of digital resource associated with said digital resource identifier;

said specified number is larger than a total number of copies of said digital resource associated with said digital resource identifier; and

said specified number is larger than a total number of copies corresponding to the use authorization type in said first request from all copies of said digital resource associated with said digital resource identifier.

Preferably, the method further comprises:

receiving, in a second receiving step, a second request submitted by the resource requester for obtaining copies of the digital resource, wherein said second request comprises the use authorization type, the identification information of the resource requester, and the digital resource identifier;

determining, in a second determining step, on the basis of the identification information of said resource requester in said second request, and the number of unique copy identifiers corresponding to the digital resource identifier in said second request but not being marked as distributed, or on the basis of the combination of the identification information of said resource requester, the number of unique copy identifiers corresponding to digital resource identifier in said second request but not being marked as distributed, and the use authorization type, whether said resource requester is allowed to obtain copies of the digital resource of said use authorization type of the digital resource associated with said digital resource identifier; and

distributing, in a second distributing step, when the determination result of said second determining step is positive, to said resource requester a copy of the digital resource of said use authorization type of the digital resource associated with said digital resource identifier, and marking one of the unique copy identifiers corresponding to the use authorization type in said second request from all unique copy identifiers of the digital resource associated with the digital resource identifier in said second request as distributed.

Preferably, said use authorization type is selected from a group consisting of borrowing type, leasing type and purchasing type.

Preferably, the method further comprises:

withdrawing, from all the distributed copies of the digital resource, the copies each with a duration from the time point when the respective copy is distributed to the current time point exceeding a specified duration, so as to prohibit the resource requester from continuing to use the copies.

Preferably, all or part of processing in at least one of said first receiving step, second receiving step, first determining step, second determining step, first distributing step, second distributing step, and withdrawing step is executed by a cloud server.

The present disclosure further provides a device for managing digital resources, comprising:

a first receiving module, used for receiving a request submitted by a resource requester for obtaining an authorization for using a specified number of copies of a digital resource, wherein said request comprises a use authorization type, an identification information of the resource requester, and a digital resource identifier;

a first determining module, used for determining, on the basis of the identification information of said resource requester, or on the basis of the combination of the identification information of said resource requester and said use authorization type, whether said resource requester is allowed to obtain the specified number of use authorizations, which correspond to said use authorization type of the digital resource associated with said digital resource identifier; and

a first distributing module, used for distributing, when the determination result of said first determining module is positive, from all copies of digital resource associated with the digital resource identifier, the specified number of copies corresponding to the use authorization type in said request to said resource requester.

Preferably, the determination result of said first determining module is negative if any one of the following conditions is satisfied:

the use authorization type in said request does not match with any use authorization type of copies of the digital resource associated with said digital resource identifier;

said specified number is larger than a total number of copies of the digital resource associated with said digital resource identifier; and

said specified number is larger than a total number of copies corresponding to use authorization type in said request from all copies of the digital resource associated with said digital resource identifier.

Preferably, the device further comprises:

a second receiving module, used for receiving a second request submitted by the resource requester for obtaining copies of the digital resource, wherein said second request comprises the use authorization type, the identification information of the resource requester, and the digital resource identifier;

a second determining module, used for determining, on the basis of the identification information of said resource requester in said second request, and the number of unique copy identifiers corresponding to the digital resource identifier in said second request but not being marked as distributed, or on the basis of the combination of the identification information of said resource requester, the number of unique copy identifiers corresponding to the digital resource identifier in said second request but not being marked as distributed, and the use authorization type, whether said resource requester is allowed to obtain copies of the digital resource of said use authorization type of the digital resource associated with said digital resource identifier; and

a second distributing module, used for distributing, when the determination result of said second determining module is positive, to said resource requester a copy of the digital resource of said use authorization type of the digital resource associated with said digital resource identifier, and marking one of the unique copy identifiers corresponding to the use authorization type in said second request from all unique copy identifiers of the digital resource associated with the digital resource identifier in said second request as distributed.

Preferably, said use authorization type is selected from a group consisting of borrowing type, leasing type and purchasing type.

Preferably, the device further comprises:

a withdrawing module, used for withdrawing from all the distributed copies of the digital resource the copies each with a duration from the time point when the respective copy is distributed to the current time point exceeding a specified duration, so as to prohibit the resource requester from continuing to use the copies.

Preferably, said device is a server in a cloud platform.

Compared with the prior art, one embodiment or a plurality of embodiments of the present disclosure has/have the following advantages. Through containing the use authorization type and the digital resource identifier in the request (the first request), determining based on the information in the request, and distributing corresponding unique copy identifiers to the resource requester, the resource requester is allowed to obtain the corresponding copies of the digital resource according to the distributed unique copy identifiers, whereby the digital resources can be circulated in a diversified manner while copyrights can be still protected.

Other features and advantages of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The accompanying drawings provide further understandings of the present disclosure and constitute one part of the description. The drawings are used for interpreting the present disclosure together with the embodiments, not for limiting the present disclosure. In the drawings:

FIG. 1A and FIG. 1B are flow charts of the method for managing digital resources according to embodiment 1 of the present disclosure; and

FIG. 2 schematically shows the device for managing digital resources according to embodiment 2 of the present disclosure.

### DETAILED DESCRIPTION OF THE EMBODIMENTS

The present disclosure will be explained in detail hereinafter in combination with the drawings to further clarify the purposes, technical solutions, and advantages thereof.

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It is important to note that as long as there is no structural conflict, all the technical features mentioned in all the embodiments may be combined together in any manner, and the technical solutions obtained in this manner all fall within the scope of the present disclosure.

In addition, the steps as shown in the flow chart in the attached drawings can be executed in a computer system by a group of computer executable instructions. Although the logical sequence is shown in the flow chart, the steps shown or described herein can be executed in other sequences different from the one shown herein in some cases.

### Embodiment 1

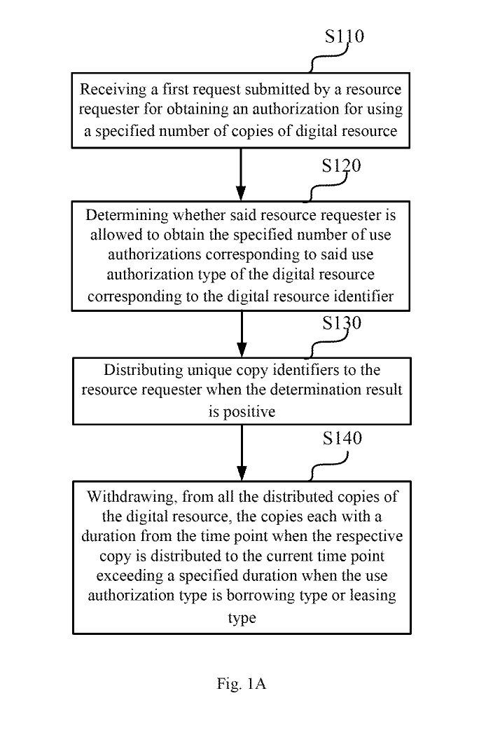

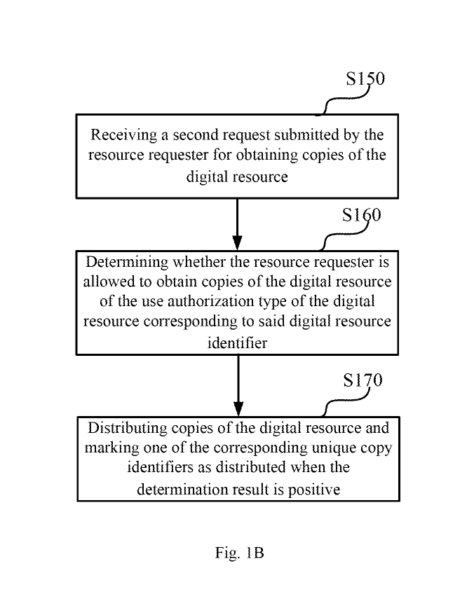

The flow chart of the method for managing digital resources according to the present embodiment is explained hereinafter with reference to FIG. 1A.

In step S110, a request (i.e., a first request) submitted by a resource requester for obtaining an authorization for using a specified number of copies of a digital resource is received. The first request comprises a use authorization type, an identification information of the resource requester, and a digital resource identifier. Then, proceed to step S120.

In step S120, whether the resource requester is allowed to obtain the specified number of use authorizations, which correspond to said use authorization type of the digital resource associated with the digital resource identifier is determined on the basis of the identification information of the resource requester and the digital resource identifier in the first request, or on the basis of the combination of the identification information of the resource requester, the digital resource identifier, and the use authorization type. If the determination result of step S120 is positive, proceed to step S130; otherwise, the process comes to an end.

In step S130, when the determination result of step S120 is positive, the specified number of unique copy identifiers, which correspond to the use authorization type in the first request from all unique copy identifiers of the digital resource associated with the digital resource identifier in the first request are distributed to the resource requester, so that the resource requester is allowed to obtain the corresponding copies of the digital resource according to the distributed unique copy identifiers.

In addition, the method may further comprise step S140. In step S140, when the use authorization type is borrowing type or leasing type, from all the distributed copies of the digital resource, the copies each with a duration from the time point when the respective copy is distributed to the current time point exceeding a specified duration are withdrawn at intervals, so as to prohibit the resource requester from continuing to use the copies.

It should be noted that, the digital resources in the present disclosure include, but not limited to, audios, videos, electronic readings (newspapers and periodicals, magazines, and books), games, software, practical information, or the combination of the above digital contents. The resource requesters include the users, the third party cooperation platforms, operation platforms, and systems.

In step S110, the use authorization type is selected from a group consisting of borrowing type, leasing type and purchasing type. That is to say, according to the solution of the present embodiment, the users may not only purchase the digital resources, but also borrow (i.e., borrow for reading) and lease (i.e., lease for reading) the digital resources. For example, the users can only buy books but cannot borrow books in traditional electronic book platforms; however, the users can not only buy books but also borrow books in the present platform. The purchased books and leased books can be managed through unique copy identifiers, whereby the phenomena in violation of relevant regulations, such as “one book being lent to more than one people at the same time”, can be avoided. In such manner, the diversification of circulation modes of electronic books can be realized as paper books.

In addition, when the use authorization type is borrowing type or leasing type, the copies, from all the distributed copies of the digital resource, if there are any, each with a duration from the time point when the respective copy is distributed to the current time point exceeding a specified duration are withdrawn, so as to prohibit the resource requester from continuing to use the copies. The specified duration can be set manually according to actual needs through the system, or can be preset by the system.

In step S120, first, whether the user is a legal and registered user is determined according to the identification information of the user, and then, whether the specified number is larger than a total number of copies corresponding to the use authorization type in said first request from all copies of said digital resource associated with said digital resource identifier is determined. If the determination results of the above two sub-steps are both positive, the determination result of step S120 is positive.

In addition, in step S120, the determination result of step S120 is negative, that is, the resource requester is not allowed to obtain the use authorizations if any one of the following conditions is satisfied: the use authorization type in the first request does not match with any use authorization type of copies of the digital resource associated with the digital resource identifier; the specified number is larger than a total number of copies of the digital resource associated with the digital resource identifier; and the specified number is larger than a total number of copies corresponding to the use authorization type in the first request from all copies of the digital resource associated with the digital resource identifier.

If the determination result of step S120 is negative, the process may come to an end, or the information that the first request goes beyond the permission may be presented to the user.

In step S130, when the determination result of step S120 is positive, the specified number of unique copy identifiers, which correspond to the use authorization type in said first request, from all unique copy identifiers of the digital resource associated with the digital resource identifier in said first request are distributed to the resource requester, so that said resource requester is allowed to obtain the corresponding copies of said digital resource according to the distributed unique copy identifiers.

In this manner, the unique copy identifiers of corresponding digital resource are distributed based on the request of resource requester, the user can access to the copy according to the unique copy identifiers thereof, and the information of use authorization type is contained in the first request, whereby the digital resources can be circulated in a diversified manner while copyrights can be still protected.

The process of the resource requester obtaining the use authorizations of digital resource is explained hereinabove. In other words, the process of the users obtaining the use authorizations of corresponding books through purchasing, leasing or borrowing is described.

The process of how to take out (copy) the books for reading conveniently after obtaining the use authorizations is stated hereinafter with reference to FIG. 1B.

In step S150, a request (i.e., a second request) submitted by the resource requester for obtaining copies of the digital resource is received, wherein the second request comprises the use authorization type, the identification information of the resource requester, and the digital resource identifier.

In step S160, whether the resource requester is allowed to obtain copies of the digital resource of the use authorization type of the digital resource associated with the digital resource identifier is determined on the basis of the identification information of the resource requester in the second request, and the number of unique copy identifiers corresponding to the digital resource identifier in the second request but not being marked as distributed, or on the basis of the combination of the identification information of the resource requester, the number of unique copy identifiers corresponding to digital resource identifier in the second request but not being marked as distributed, and the use authorization type. It can be seen that, through the application of unique copy identifiers, the user who owns one unique copy identifier can only use the copy corresponding to the unique copy identifier, but cannot distribute the same copy to other users or other terminals of the same user at the same time.

In step S170, when the determination result of step S160 is positive, copies of the digital resource of the use authorization type of the digital resource associated with the digital resource identifier are distributed to the resource requester, and one of the unique copy identifiers corresponding to the use authorization type in the second request from all unique copy identifiers of the digital resource associated with the digital resource identifier in the second request is marked as distributed.

In addition, all or part of processing in at least one of the steps S110 to S170 is executed by a cloud server.

### Embodiment 2

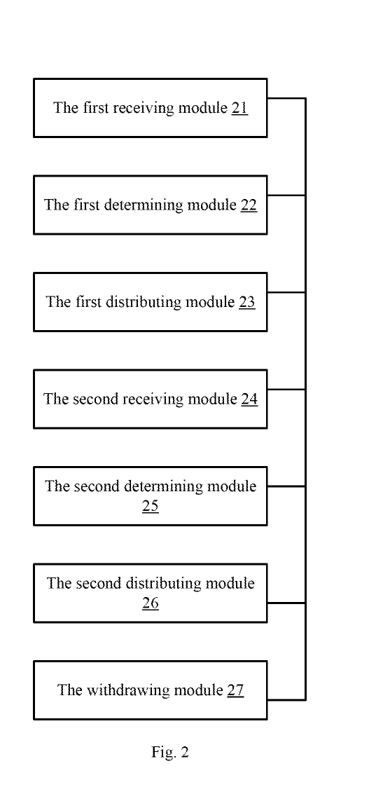

The device for managing digital resources according to the present embodiment is interpreted hereinafter with reference to FIG. 2. The device comprises the following modules.

A first receiving module 21 is used for receiving a request submitted by a resource requester for obtaining an authorization for using a specified number of copies of a digital resource, wherein the request comprises a use authorization type, an identification information of the resource requester, and a digital resource identifier.

A first determining module 22 is used for determining, on the basis of the identification information of the resource requester, or on the basis of the combination of the identification information of the resource requester and the use authorization type, whether the resource requester is allowed to obtain the specified number of use authorizations, which correspond to the use authorization type of the digital resource associated with the digital resource identifier.

A first distributing module 23 is used for distributing, when the determination result of the first determining module is positive, from all copies of digital resource associated with the digital resource identifier, the specified number of copies corresponding to the use authorization type in said request to said resource requester.

The device can further comprise the following modules.

A second receiving module 24 is used for receiving a second request submitted by the resource requester for obtaining copies of the digital resource, wherein the second request comprises the use authorization type, the identification information of the resource requester, and the digital resource identifier;

A second determining module 25 is used for determining, on the basis of the identification information of the resource requester in the second request, and the number of unique copy identifiers corresponding to the digital resource identifier in said second request but not being marked as distributed, or on the basis of the combination of the identification information of said resource requester, the number of unique copy identifiers corresponding to the digital resource identifier in said second request but not being marked as distributed, and the use authorization type, whether said resource requester is allowed to obtain copies of the digital resource of said use authorization type of the digital resource associated with said digital resource identifier; and

A second distributing module 26 is used for distributing, when the determination result of the second determining module is positive, to the resource requester a copy of the digital resource of the use authorization type of the digital resource associated with the digital resource identifier, and marking one of the unique copy identifiers corresponding to the use authorization type in the second request from all unique copy identifiers of the digital resource associated with the digital resource identifier in the second request as distributed.

It should be noted that, the steps S110, S120, and S130 in embodiment 1 are executed by the first receiving module 21, the first determining module 22, and the first distributing module 23 respectively, and the steps S150, S160, S170, and S140 are executed by the second receiving module 24, the second determining module 25, the second distributing module 26, and a withdrawing module 27 respectively. The descriptions of the steps in embodiment 1 are applicable for the corresponding devices in the present embodiment.

Preferably, the device is a server in a cloud platform.

Apparently, it could be understood by a person skilled in the art that, each of the modules and steps of the above invention can be realized with a general computing device. They can be centralized in one single computing device, or can be distributed in a network consisting of a plurality of computing devices. Optionally, they can be realized with program codes executable in computing devices, and can thus be stored in storage devices to be executed by the computing devices. Alternatively, they can be made into integrated circuit modules respectively, or a plurality of modules or steps of them can be made into one single integrated circuit module. In this manner, the present invention is not limited to any specific combination of hardware and software.

The above embodiments are described only for better understanding, rather than restricting, the present disclosure. Any person skilled in the art can make amendments to the implementing forms or details without departing from the spirit and scope of the present disclosure. The protection scope of the present disclosure shall be determined by the scope as defined in the claims.

1. A method for managing digital resources, comprising the steps of:
receiving, in a first receiving step, a first request submitted by a resource requester for obtaining an authorization for using a specified number of copies of a digital resource, wherein said first request comprises a use authorization type, an identification information of the resource requester, and a digital resource identifier;
determining, in a first determining step, on the basis of the identification information of said resource requester and said digital resource identifier in said first request, or on the basis of the combination of the identification information of said resource requester, said digital resource identifier, and said use authorization type, whether said resource requester is allowed to obtain the specified number of use authorizations, which correspond to said use authorization type of the digital resource associated with said digital resource identifier; and
distributing, in a first distributing step, when the determination result of said first determining step is positive, to said resource requester the specified number of unique copy identifiers, which correspond to the use authorization type in said first request, from all unique copy identifiers of the digital resource associated with the digital resource identifier in said first request, so that said resource requester is allowed to obtain the corresponding copies of said digital resource according to the distributed unique copy identifiers.

2. The method according to claim 1, wherein the determination result of said first determining step is negative if any one of the following conditions is satisfied:
the use authorization type in said first request does not match with any use authorization type of copies of digital resource associated with said digital resource identifier;
said specified number is larger than a total number of copies of said digital resource associated with said digital resource identifier; and
said specified number is larger than a total number of copies corresponding to the use authorization type in said first request from all copies of said digital resource associated with said digital resource identifier.

3. The method according to claim 1, further comprising the steps of:
receiving, in a second receiving step, a second request submitted by the resource requester for obtaining copies of the digital resource, wherein said second request comprises the use authorization type, the identification information of the resource requester, and the digital resource identifier;
determining, in a second determining step, on the basis of the identification information of said resource requester in said second request, and the number of unique copy identifiers corresponding to the digital resource identifier in said second request but not being marked as distributed, or on the basis of the combination of the identification information of said resource requester, the number of unique copy identifiers corresponding to digital resource identifier in said second request but not being marked as distributed, and the use authorization type, whether said resource requester is allowed to obtain copies of the digital resource of said use authorization type of the digital resource associated with said digital resource identifier; and
distributing, in a second distributing step, when the determination result of said second determining step is positive, to said resource requester a copy of the digital resource of said use authorization type of the digital resource associated with said digital resource identifier, and marking one of the unique copy identifiers corresponding to the use authorization type in said second request from all unique copy identifiers of the digital resource associated with the digital resource identifier in said second request as distributed.

4. The method according to claim 1, wherein said use authorization type is selected from a group consisting of borrowing type, leasing type and purchasing type.

5. The method according to claim 4, further comprising:
withdrawing, from all the distributed copies of the digital resource, the copies each with a duration from the time point when the respective copy is distributed to the current time point exceeding a specified duration, so as to prohibit the resource requester from continuing to use the copies.

6. The method according to claim 5, wherein all or part of processing in at least one of said first receiving step, second receiving step, first determining step, second determining step, first distributing step, second distributing step, and withdrawing step is executed by a cloud server.

7. A device for managing digital resources, comprising:
a first receiving module, used for receiving a request submitted by a resource requester for obtaining an authorization for using a specified number of copies of a digital resource, wherein said request comprises a use authorization type, an identification information of the resource requester, and a digital resource identifier;
a first determining module, used for determining, on the basis of the identification information of said resource requester, or on the basis of the combination of the identification information of said resource requester and said use authorization type, whether said resource requester is allowed to obtain the specified number of use authorizations, which correspond to said use authorization type of the digital resource associated with said digital resource identifier; and
a first distributing module, used for distributing, when the determination result of said first determining module is positive, from all copies of digital resource associated with the digital resource identifier, the specified number of copies corresponding to the use authorization type in said request to said resource requester.

8. The device according to claim 7, wherein the determination result of said first determining module is negative if any one of the following conditions is satisfied:
the use authorization type in said request does not match with any use authorization type of copies of the digital resource associated with said digital resource identifier;
said specified number is larger than a total number of copies of the digital resource associated with said digital resource identifier; and
said specified number is larger than a total number of copies corresponding to use authorization type in said request from all copies of the digital resource associated with said digital resource identifier.

9. The device according to claim 7, further comprising:
a second receiving module, used for receiving a second request submitted by the resource requester for obtaining copies of the digital resource, wherein said second request comprises the use authorization type, the identification information of the resource requester, and the digital resource identifier;
a second determining module, used for determining, on the basis of the identification information of said resource requester in said second request, and the number of unique copy identifiers corresponding to the digital resource identifier in said second request but not being marked as distributed, or on the basis of the combination of the identification information of said resource requester, the number of unique copy identifiers corresponding to the digital resource identifier in said second request but not being marked as distributed, and the use authorization type, whether said resource requester is allowed to obtain copies of the digital resource of said use authorization type of the digital resource associated with said digital resource identifier; and
a second distributing module, used for distributing, when the determination result of said second determining module is positive, to said resource requester a copy of the digital resource of said use authorization type of the digital resource associated with said digital resource identifier, and marking one of the unique copy identifiers corresponding to the use authorization type in said second request from all unique copy identifiers of the digital resource associated with the digital resource identifier in said second request as distributed.

10. The device according to claim 7, wherein said use authorization type is selected from a group consisting of borrowing type, leasing type and purchasing type.

11. The device according to claim 10, further comprising:
a withdrawing module, used for withdrawing from all the distributed copies of the digital resource the copies each with a duration from the time point when the respective copy is distributed to the current time point exceeding a specified duration, so as to prohibit the resource requester from continuing to use the copies.

12. The device according to claim 10, wherein said device is a server in a cloud platform.
